(19) United States
(12) Patent Application Publication
(10) Pub. No.: US 2023/0059255 A1
(43) Pub. Date: Feb. 23, 2023

(54) METHOD AND SYSTEM FOR DETERMINING LIQUID LEVELS IN SAND FILTERS AND EFFECTIVE AIR SCOURING DURING BACKWASH

(71) Applicant: SAUDI ARABIAN OIL COMPANY, Dhahran (SA)

(72) Inventor: Mashhour Abdullah Basurrah, Khobar (SA)

(73) Assignee: SAUDI ARABIAN OIL COMPANY, Dhahran (SA)

(21) Appl. No.: 17/406,176

(22) Filed: Aug. 19, 2021

(51) Int. Cl. B01D 24/46; B01D 24/10; B01D 24/48

(52) U.S. Cl. CPC B01D 24/4631; B01D 24/105; B01D 24/4869; B01D 24/4884; B01D 2101/04; B01D 2201/54

(57) ABSTRACT

A filter device may include a tank, a drainage section at a lower most end of the tank, a filter medium above the drainage section and below an upper most end of the tank, and a plurality of sensors provided on the tank. A first sensor may be configured to measure a first height of the filter medium. A second sensor and third sensor may be configured to measure a second height of fluids within the tank. Additionally, air is configured to be pumped through the filter medium during an air scouring cycle. A control system may be operational coupled to the filter device, the control system may be configured to maintain the fluids at the second height at a predetermined distance of one inch above the first height during the air scouring cycle.

### BACKGROUND

In various industries, fluids may be filtered to separate liquids and solids. For example, the fluids may be desalinated or treated to reduce contamination to reach an acceptable concentration for use. In various industries, such as, oil and gas wells, gas plants, desalination plants, wastewater treatment plants, and individual households, a sand filter may be used to treat fluids. Sand filters may have a filter bed within a tank. The filter bed may include layers of a filter medium (e.g., sand) therein. A pre-treated raw water enters the tank and flows through the filter medium. Additionally, the effluent (i.e., waste) drains through a drainage system in the lower part. After flowing through the filter medium, the pre-treated raw water is now treated, and the filtered water may exit the tank via the drainage system. Large process plants have also a system implemented to evenly distribute the raw water to the sand filters. In addition, a distribution system controlling the air flow is usually included. The distribution system may allow a constant air and water distribution to the sand filters. During the filtration process, a grain distribution of the filter medium may alter and accumulated solids from the filter bed may be removed.

In water treatment, backwashing operations may be conducted in sand filters to pump water backwards through the filter medium in the sand filters. Backwashing operations may include multiple steps to allow the filter medium to be reused. First, water is drained to a level that is above a surface of the filter bed within the sand filter. Next, an air scour cycle may occur. In the air scouring cycle, air may be pushed up through the filter medium causing the filter bed to expand breaking up the compacted grains of the filter medium and force the grains into suspension. After the air scour cycle, clean backwash water is forced upwards through the filter bed continuing the filter bed expansion and carrying the grains in suspension into backwash troughs suspended above the filter surface. Backwashing may continue for a fixed time. At the end of the backwash cycle, the upward flow of water is terminated, and the filter bed settles by gravity into its initial configuration. At this point, the filter medium may be rejuvenating and reused such that pre-treated raw water may re-enter the sand filter to be filtered until further backwash cycles are needed.

Conventional filtration systems in the water treatment industry typically require large and costly equipment to detect fluid levels and restore filter mediums. Such conventional filtration systems may also be more expensive because of the higher number of parts and components along with design and installation costs. Additionally, conventional filtration systems assume a fixed filter medium level to only measure a fluid level without addressing variable interfaces levels between the fluid and filter medium. Further, conventional filtration systems may require a set flow rate such that adjusting a fluid level in real-time may not be possible. Conventional filtration systems may also require determining a density of fluids to calculate fluid levels.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for conducting a backwashing operation of a filter medium in a tank. A first height of the filter medium may be predetermined based on a first time measurement of a first signal transmitted from a first sensor positioned on a top of the tank. The method may include draining fluids in the tank to be one inch above the filter medium, and pumping air through the filter medium in an air scouring operation. The method may also include measuring a second height of the fluid within the tank based on a differential pressure reading of a second sensor and a third sensor positioned on the tank, and measuring a third height of an upper most surface of the fluid/filter medium mixture based on a second time measurement of a second signal transmitted by the first sensor. The method may further include determining if the upper most surface of the fluid/filter medium mixture is the fluid or the filter medium based on a difference between the first height and the second height, and maintaining the second height at one inch above the first height.

In another aspect, embodiments disclosed herein relate to a filtration system with a filter device. The filter device may include a tank, a drainage section at a lower most end of the tank, a filter medium above the drainage section and below an upper most end of the tank, and a plurality of sensors provided on the tank. A first sensor of the plurality of sensors may be on a top of the tank, a second sensor of the plurality of sensors may be on an upper most end of the tank, and a third sensor of the plurality of sensors may be on a lower most end of the tank. The first sensor may be configured to measure a first height of the filter medium. The second sensor and the third sensor may be configured to measure a second height of fluids within the tank. Additionally, air is configured to be pumped through the filter medium during an air scouring cycle. A control system may be operational coupled to the filter device, the control system may be configured to maintain the fluids at the second height at one inch above the first height during the air scouring cycle.

In yet another aspect, embodiments disclosed herein relate to a filtration system. The filtration system may include an untreated fluid reservoir fluidly connected to a filter device, untreated fluids from the untreated fluid reservoir are configured to be injected into the filter device; a treated fluid reservoir fluidly connected to the filter device, treated fluids from the filter device are configured to be injected the untreated fluid reservoir; and a waste fluid reservoir fluidly connected to the filter device, waste fluids from the filter device are configured to be injected the waste fluid reservoir. The filter device may include a tank; a drainage section at a lower most end of the tank; a filter medium above the drainage section and below an upper most end of the tank; a plurality of sensors provided on the tank, the plurality of sensors being configured to measure a first height of the filter medium within the tank and measure a second height of fluids within the tank; and a control system configured to maintain, by increasing or decreasing a volume of the fluids, the second height one inch above the first height based on data from the plurality of sensors.

Other aspects and advantages of the invention will be apparent from the following description and the appended claims.

### BRIEF DESCRIPTION OF DRAWINGS

The following is a description of the figures in the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, shapes of the elements as drawn are not necessarily intended to convey any information regarding the actual shape of the elements and have been solely selected for ease of recognition in the drawing.

FIG. 1 illustrates a schematic diagram of a filtration system in accordance with embodiments disclosed herein.

FIGS. 2A-2H illustrate a schematic close-up diagram of a filter device from the filtration system of FIG. 1 in accordance with embodiments disclosed herein

FIG. 3 illustrates a view of a human machine interface (“HMI”) of the filtration system of FIGS. 1-2H according to one or more embodiments of the present disclosure.

FIG. 4 is a flowchart of a method in accordance with embodiments disclosed herein.

FIG. 5 is a schematic diagram of a computing system in accordance with embodiments disclosed herein.

### DETAILED DESCRIPTION

In the following detailed description, certain specific details are set forth to provide a thorough understanding of various disclosed implementations and embodiments. However, one skilled in the relevant art will recognize that implementations and embodiments may be practiced without one or more of these specific details, or with other methods, components, materials, and so forth. For the sake of continuity, and in the interest of conciseness, same or similar reference characters may be used for same or similar objects in multiple figures. As used herein, the term “coupled” or “coupled to” or “connected” or “connected to” “attached” or “attached to” may indicate establishing either a direct or indirect connection, and is not limited to either unless expressly referenced as such. As used herein, fluids may refer to slurries, liquids, gases, and/or mixtures thereof without departing from the scope of the present disclosure.

Embodiments disclosed herein are directed to filtration systems to treat water in sand filters. More specifically, embodiments disclosed herein are directed to determining and controlling a fluid level within a sand filter. The different embodiments described herein may provide a filtration system having a sand filter with a plurality of sensors to determine a fluid level within a sand filter and a controller to control a volume of fluids entering the sand filter. By using the filtration system for water treatment operations disclosed herein, the filtration system may enhance a filtration process and prolong a filtration medium compared to conventionally used filtration systems. Further, a configuration and arrangement of the filtration system to determine and control fluid levels within a sand filter during water treatment operations according to one or more embodiments described herein may provide a cost-effective alternative to conventional filtration systems. For example, one or more embodiments described herein may increase the life of the filtration medium within the filtration system while the filtration medium in conventional filtration systems shorter life spans. The embodiments are described merely as examples of useful applications, which are not limited to any specific details of the embodiments herein.

In accordance with one or more embodiments, a filtration system includes a sand filter to treat water. In one or more embodiments, the sand filter may be a tank or vessel containing a filter medium. The tank may include one or more inlets to receive fluids and one or more outlets for fluids to exit the tank. Further, three or more sensors may be provided on or within the tank to measure, monitor, and transmit fluid and filter medium data within the tank to a control system. The control system may process the transmitted data to determine fluid levels within the tank to maintain a fluid level at a predetermined height with respect to the filter medium during air scouring in a backwashing operation.

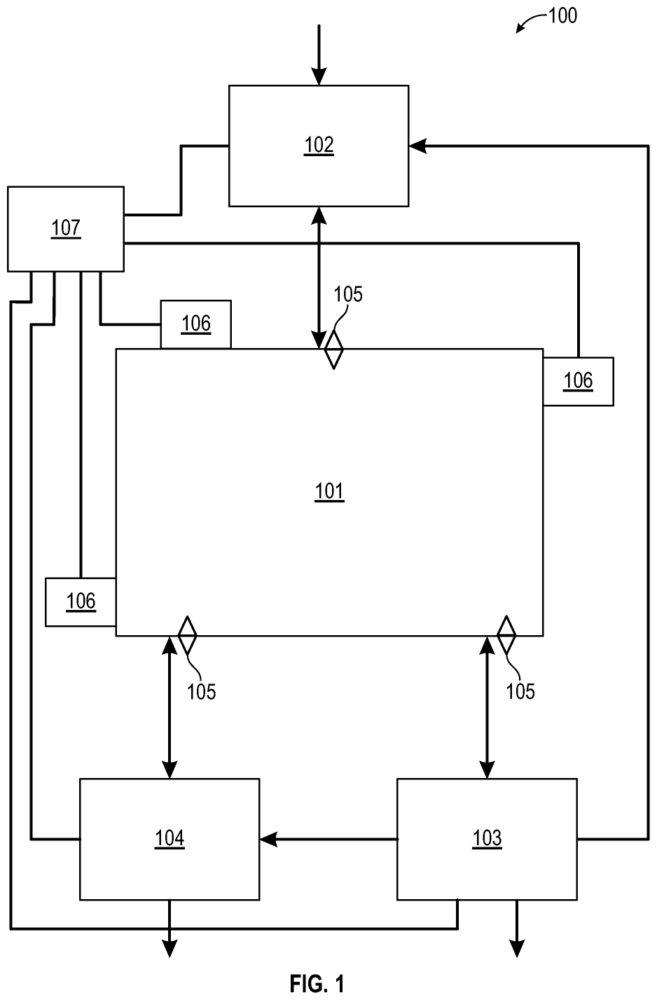

Referring to FIG. 1, a filtration system 100 in accordance with embodiments disclosed herein is illustrated. The filtration system 100 may include a filter device 101, an untreated fluid reservoir 102, a treated fluid reservoir 103, and a waste fluid reservoir 104 fluidly coupled together. The filter device 101 may be a tank, vessel, container, or any type of reservoir that contains fluids and filter mediums. The untreated fluid reservoir 102 may be a tank, vessel, container, or any type of reservoir that contains untreated fluids. The treated fluid reservoir 103 may be a tank, vessel, container, or any type of reservoir that contains treated fluids. The waste fluid reservoir 104 may be a tank, vessel, container, or any type of reservoir that contains waste fluids. Those skilled in the art will appreciate that the reservoirs 101, 102, 103, 104 may all be a single storage facility with dividers delineating each of the different fluids or may be separate, disjoint reservoirs operatively connected with each other.

In one or more embodiments, the filter device 101 of the filtration system 100 is a sand filter to treat fluids from the untreated fluid reservoir 102, the treated fluid reservoir 103, and the waste fluid reservoir 104. For example, untreated fluid from the untreated fluid reservoir 102 enters the filter device 101 and flows through a filter medium within the filter device 101. The filter medium of the filter device 101 may treat/filter the untreated fluid such that treated fluids exit the filter device 101 and enter the treated fluid reservoir 103. From the treated fluid reservoir 103, the treated fluid may be transported to a destination for use. Additionally, during the treatment process, waste fluid is produced in the filter device 101 from the filter medium treating/filtering the untreated fluid. The waste fluid may exit the filter device 101 and enter the waste fluid reservoir 104. From the waste fluid reservoir 104, the waste fluid may be transported to a waste facility.

In some embodiments, fluid may flow between the various components of the filtration system 100. For example, treated fluids in the treated fluid reservoir 103 may be injected back into the filter device 101 for backwash operations or to be re-filtered. Additionally, the treated fluids in the treated fluid reservoir 103 may also be injected into to the untreated fluid reservoir 102 and the waste fluid reservoir 104 to dilute the fluids within the corresponding reservoirs (102, 104). It is further envisioned that the treated fluids may be injected into the untreated fluid reservoir 102 directly from the filter device 101. Further, waste fluids in the waste fluid reservoir 104 may be injected into the filter device 101 to be treated/filtered. It is further envisioned that nozzles 105 may be provided at inlets/outlets of the filter device 101 to control an injection rate of the fluids.

Still referring to FIG. 1, in one or more embodiments, a plurality of sensors 106 are provided on or within the filter device 101. Specifically, three or more sensors 106 may be a microphone, ultrasonic, ultrasound, sound navigation and ranging (SONAR), radio detection and ranging (RADAR), a non-contact guided wave radar transmitter, acoustic, piezoelectric, accelerometers, temperature, pressure, weight, position, or any type of sensor to detect and monitor the filter device 101 and the fluids therein. The plurality of sensors 106 may transmit a span of 4-20 mA where 20 mA represents a maximum height of the liquid, i.e., 100% or actual maximum height in centimeters, meters, inches, feet, or other units to measure height. The plurality of sensors 106 may be used to collect data on status, process conditions, performance, and overall quality of the filter device 101, for example, on/off status of the filter device 101, open/closed status of inlets and outlets, nozzles flow rates, pressure readings, temperature readings, time stamps, and others.

In some embodiments, the plurality of sensors 106 may transmit and receive information/instructions wirelessly and/or through wires via a control system 107. For example, each sensor of the plurality of sensors 106 may have an antenna (not shown) to be in communication (e.g., transmit and receive information/instructions) with the control system 107. The control system 107 may be onsite or at a remote location away from the site. For example, the control system 107 may be a control panel on or near the filter device 101, or in a housing such as a control room where an operator may be within to operator and view the filter device 101, or in a remote location away from the site.

In one aspect, the plurality of sensors 106 may be used to provide information such that a fluid level within the filter device 101, a height of filter medium within the filter device 101, and a height of the upper most level of a fluid/filter medium mixture within the filter device 101 may be obtained by the control system 107. By obtaining such information, the control system 107 may automatically control and adjust a volume of fluids entering the filter device 101 such the fluid level within the filter device 101 is maintained at a predetermined distance, such as at one inch (2.54 centimeters), above the height of filter medium, during backwashing operations, without inspection and reduce or eliminate human interaction with the filtration system 100.

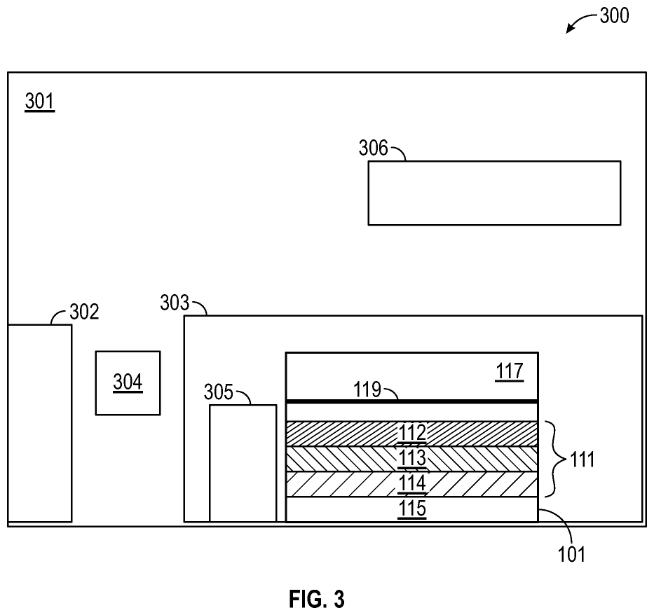

In one or more embodiments, the control system 107 may include a computing system for implementing methods disclosed herein. The computing system may include a human machine interface (“HMI”) (shown in FIG. 3 below) using a software application and may be provided to aid in the automation of the filtration system 100. In some embodiments, an HMI, such as a computer, control panel, and/or other hardware components may allow the operator to interact through the HMI with the filtration system 100. The HMI may include a screen, such as a touch screen, used as an input (e.g., for a person to input commands) and output (e.g., for display) of the computing system. In some embodiments, the HMI may also include switches, knobs, joysticks and/or other hardware components which may allow an operator to interact through the HMI with the filtration system 100.

The plurality of sensors 106 work in conjunction with the control system 107 to display information on the HMI. Having the filtration system 100 may significantly improve overall performance of the filter device 101, increase the life of the filter medium within the filter device 101, reduced risk of (non-productive time) NPT and many other advantages. Embodiments of the present disclosure describe control systems, measurements, and strategies to automating filtration operations (e.g., maintaining a fluid level at a predetermined height). It is further envisioned that the control system 107 may locally collect, analyze, and transmit data to a cloud in real-time to provide information, such as fluid levels, performance metrics, alerts, and general monitoring, to third parties remotely or through the HMI.

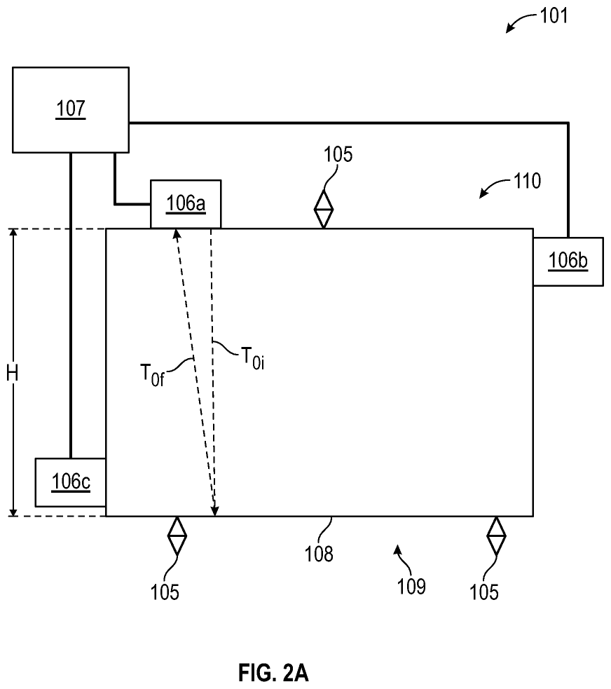

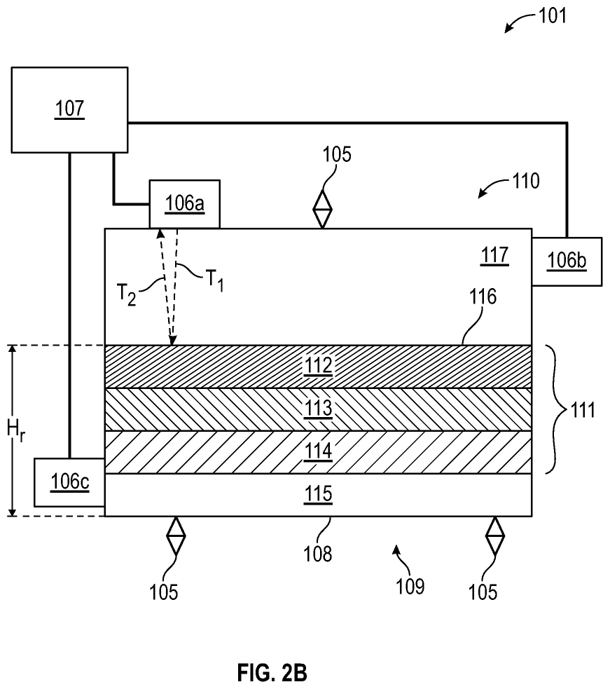

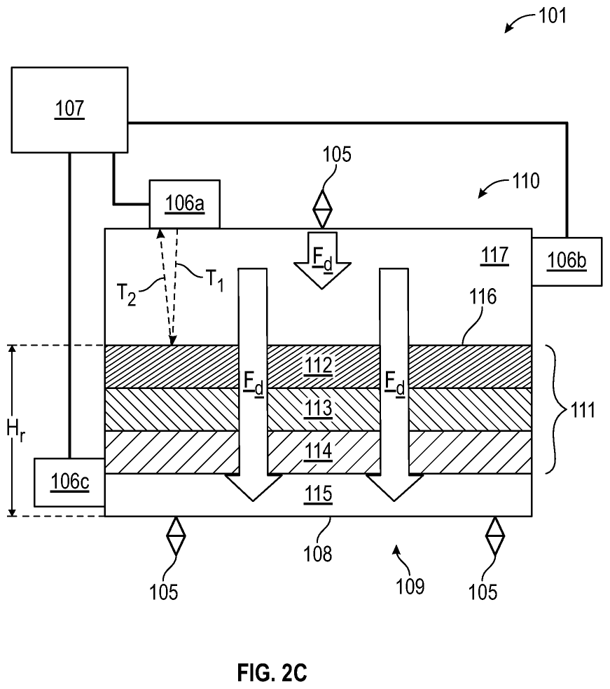

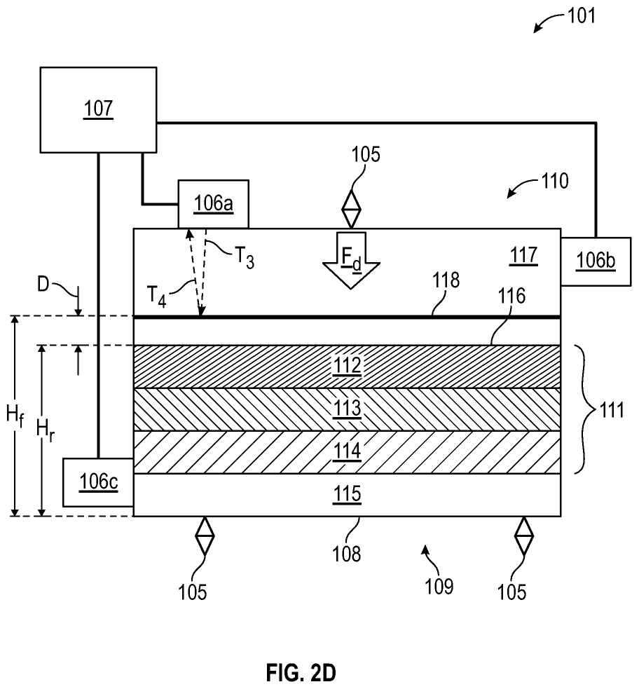

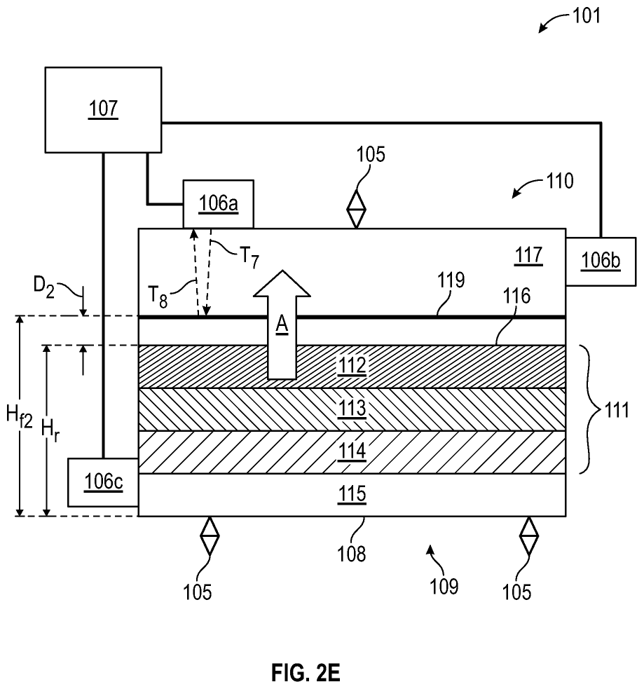

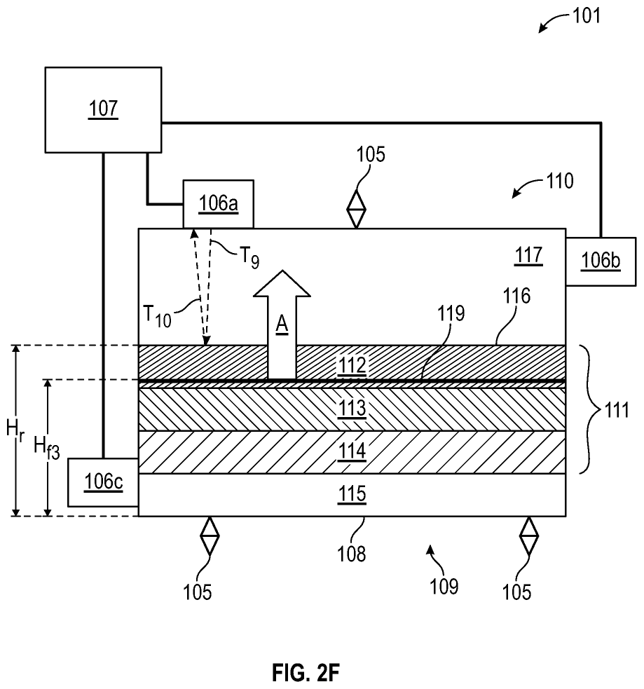

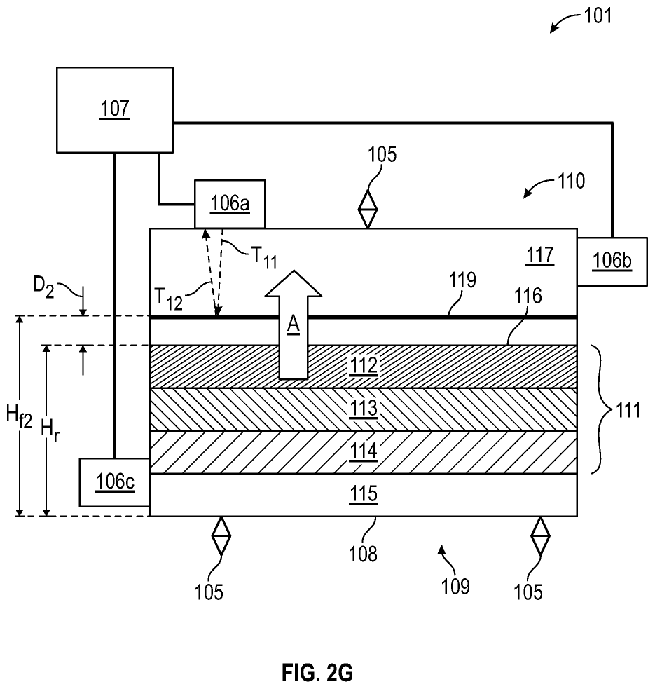

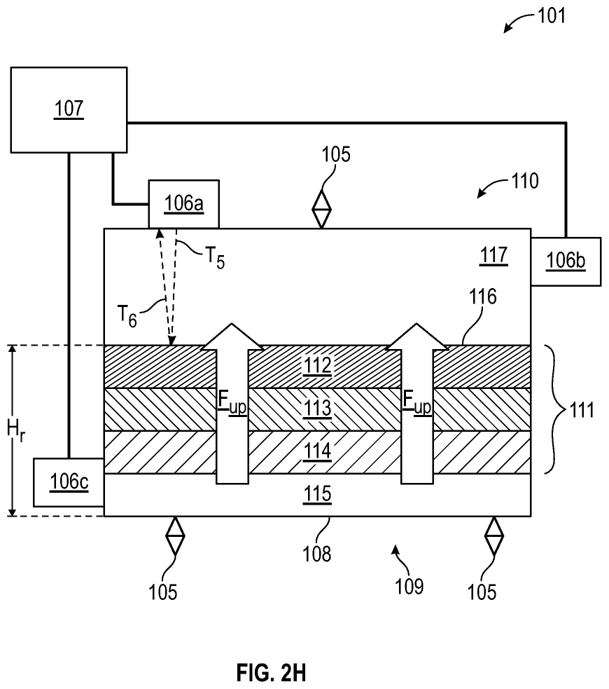

In one or more embodiments, the plurality of sensors 106 may communicate with the software application on the control system 107 to automate the filtration system 100, such as the filter device 101. In a non-limiting example, filtration operations may include an automated sequencing based on pre-approved sequence as shown in FIGS. 2A-2I.

With reference to FIGS. 2A-2D, FIGS. 2A-2D show a non-limiting example of a filtration sequence within the filter device 101 of FIG. 1. the filter device 101 may include a tank 108 having lower most end 109 and an upper most end 110. The tank 108 may be any tank, vessel, or container capable of holding fluids. At the upper most end 110, the filter device 101 may receive fluids from an untreated fluid reservoir (see 102 of FIG. 1). At the lower most end 109, the filter device 101 may inject fluids to a treated fluid reservoir (see 103 of FIG. 1) and a waste fluid reservoir 104 (see 104 of FIG. 1). In some embodiments, the filter device 101 may receive fluids from the treated fluid reservoir (see 103 of FIG. 1) at the lower most end 109 when backwashing operations are conducted. Additionally, the nozzles may be provided at the lower most end 109 and the upper most end 110 for the injection of fluids.

As illustrated in FIGS. 2A-2H, a plurality of sensors (106a, 106b, 106c) may be provided on or within the filter device 101. For example, a first sensor 106a is provided on a top of the tank 108. A second sensor 106b is provided at the upper most end 110 of the tank 108. A third sensor 106c is provided at the lower most end 109 of the tank 108. The first sensor 106a, the second sensor 106b, and the third sensor 106c are used to measure, collect, and transmit data to be processed by the control system 107. More specifically, in one or more embodiments, the sensors 106b, 106c are pressure sensors or transmitters for calculating pressure differentials, and sensor 106a is a non-contact guided wave radar transmitter for determining a reference height of the fluid level in the tank 108 in real-time. Those skilled in the art will appreciate that while three sensors are shown in the drawings of this disclosure, any suitable number of sensors, for example two sensors only, may be employed for pressure calculations and for determining the reference level for the sand filtration media, as is described further in FIG. 2D below. Further, sensor 106a may be any sensor capable of determining a height of the uppermost reference level in the tank.

In one or more embodiments, the control system 107 is pre-calibrated before the filter medium 111 is disposed within the tank 108. As shown in FIG. 2A, while the tank 108 is empty, the control system 107 instructs the first sensor 106a to send an initial signal down (see dashed line T₀ᵢ) in the tank 108 and the first sensor 106a creates an initial time stamp upon sending the initial signal. The initial signal travels down the tank 108 and reflect off the lower most end 109 of the tank 108 and return (see dashed line T_{0f}) to the first sensor 106a. Once the reflected initial signal is received by the first sensor 106a, the first sensor 106a may create a final time stamp. The first sensor 106a may then send both the initial time stamp and the final time stamp to the control system 107. The control system 107 then processes the initial time stamp and the final time stamp to determine a total travel time of the initial signal.

For example, in accordance with one or more embodiments, total travel time=final time stamp—the initial time stamp. Based on the total travel time, the control system 107 may determine a height H of tank 108 to pre-calibrate the first sensor 106a. One skilled in the art will appreciate how pre-calibrating the first sensor 106a may allow the control system 107 to be used on any size and shape of the tank 108.

Now referring to FIGS. 2B-2H, in one or more embodiments, a filter medium 111 is disposed in the tank 108 to treat fluids flowing downward therein. The filter medium 111 includes a media such as sand, anthracite, granular activated carbon (GAC), garnet, ilmenite, metal salts, or a combination thereof to filter fluids flowing through the filter medium 111. For example, the filter medium 111 may be used in coagulation, flocculation, or sedimentation treatment. In coagulation treatment, the filter medium 111 may promote a clumping of fines into larger floc so that they can be more easily separated from the fluid flowing through the filter device 101. In flocculation treatment, the filter medium 111 may cause colloidal particles to come out of suspension from the fluid flowing through the filter device 101 to sediment under the form of floc or flake. In sedimentation treatment, the filter medium 111 may use gravity to remove suspended solids from the fluid flowing through the filter device 101.

For illustration purposes, the filter medium 111 is a filter bed with a single or multiple filter media layers. For example, the filter medium 111 may include a first layer 112, a second layer 113 below the first layer 112, and a third layer 114 below the second layer 113. It is noted that while only three layers 112-114 are shown, this is shown for illustration purposes only and the filter medium may include any suitable number of layers without departing from the scope of the present disclosure. For example, the filter medium may be a single layer filter. From the first layer 112 to the third layer 114, a grain size of the filter medium 111 may gradually increase such that the smallest grain size is within the first layer 112 and the largest grain size is within the third layer 114. By having a gradually increase in the grain size of the filter medium 111, the first layer 112 may be a fine sand layer, the second layer 113 may be a coarse sand layer, and the third layer 114 may be a gravel support layer. In some embodiments, the filter medium 111 may be a monomedia such that the filter medium 111 is a one layered filter. Furthermore, a head space 117 may be formed above a top surface 116 of the filter medium 111. The head space 117 may be an empty space formed in the tank 108 above the filter medium 111.

In some embodiments, a biologically active film (not shown), such as a schmutzdecke layer, forms on top of the first layer 112. The schmutzdecke layer may consist of various biological materials such as a gelatinous biofilm matrix of bacteria, fungi, protozoa, rotifera and a range of aquatic insect larvae. As the schmutzdecke layer ages, more algae tend to develop, and larger aquatic organisms may be present including some bryozoa, snails and annelid worms. The schmutzdecke layer may improve, in conjunction with the filter medium 111, an efficiency of purification operations within the filter device 101.

Underneath the filter medium 111 at the lower most end 109, the tank 108 includes a drainage section 115. The drainage section 115 has nozzles 105 to inject various fluids from outlets of the filter device 101. For example, one nozzle 105 may be used to push treated fluids out of the filter device 101 while another nozzle 105 may be used to push waste fluids out of the filter device 101. In some embodiments, the drainage section 115 uses gravity to inject the various fluids out of outlets of the filter device 101. However, in backwashing operations, one of the nozzles 105 is used to inject treated water back through the drainage section 115 and upward through the filter medium 111.

In FIG. 2B, the filter device 101 only has the filter medium 111 within the tank 108 as an initial step. At this point, the first sensor 106a sends additional time data packets (see dashed lines T₁ and line T₂), as described in FIG. 2A, to the control system 107 to determine a reference height Hᵣ of the filter medium 111. For example, as the tank 108 now contains the filter medium 111, when the first sensor 106a sends a second signal travels downward, the second signal reflects off a top surface 116 of the filter medium 111 such that the additional time data packets (see dashed lines T₁ and line T₂) correspond to the reference height Hᵣ of the filter medium 111. The control system 107 then determines the reference height Hᵣ of the filter medium 111 by comparing the time data packets of the second signal to the time data packets of the initial signal and the determined height (see H in FIG. 2A) of the tank. One skilled in the art will appreciate how the control system 107 may store the reference height Hᵣ for further use. It is further envisioned that the reference height Hᵣ of the filter medium 111 may only be reduced when the filter medium 111 is migrated through an outlet, such as a leak. During typical operations, the reference height Hᵣ of the filter medium 111 is not variable once set in the tank 108.

Now referring to FIG. 2C, in one or more embodiments, fluids, such as raw untreated water, enters the filter device 101 via the nozzle at the upper most end 110 of the tank 108. The fluids flow downward (see block arrows F_{d}) and through the filter medium 111. In some embodiments, a diffuser (not shown) may be provided in the tank 108 to evenly distribute the fluids to the filter medium 111. As the fluid flows through the filter medium 111, the fluid may be treated by the filter medium 111 such that a treat fluid enters the drainage section 115 and exits the tank 108 via the nozzle 105 at the lower end 109 of the tank 108. However, as the fluids flow through the filter medium 111, fluids build up (see FIG. 2D) in the tank as they flow through the filter medium 111, as drainage of the treated fluid is not immediate.

In some embodiments, as the fluids enter the tank 108, the first sensor 106a is configured to periodically or continuously send signals downward, as described above, to provide data to the control system 107, such that the reference height Hᵣ of the filter medium 111 may be updated in real-time. For this purpose, the first sensor 106a may be a non-contact guided wave radar transmitter. One skilled in the art will appreciate how even if the filter medium 111 is migrated and the level becomes lower, a new reference height Hᵣ of the filter medium 111 may be redetermined by the methods above.

Now referring to FIG. 2D, as the fluids continue to flow (see block arrow F_{d}) into and fill the tank 108, the control system 107 determines a fluid level 118. The fluid level 118 represents a height H_{f} of the fluid within the tank 108. In some embodiments, when the height H_{f} of the fluid reaches a predetermined height, the flow of fluids may be stopped. For example, the second sensor 106b may measure a pressure within the tank 108 at the upper most end 110. The third sensor 106c may measure a pressure within the tank 108 at the lower most end 109. The second sensor 106b and the third sensor 106c send the measured pressure to the control system 107 to undertake a differential pressure measurement. A differential pressure) between the second sensor 106b and the third sensor 106c is determined and used in a calculation to derive the fluid level 118. For example, in one or more embodiments, the differential pressure is the measured pressure at the second sensor 106b subtracted from the measured pressure at the third sensor 106c. The differential pressure is used to calculate the fluid level 118 based on Equation 1 below.

H=ΔP÷SG [Equation 1]

In Equation 1, H is the height of the fluid (e.g., the fluid level 118), AP is the differential pressure (e.g., the pressure difference of the measured pressure at the second sensor 106b subtracted from the measured pressure at the third sensor 106c), and SG is the Specific Gravity of the fluid. As such the fluids are continuously flowing and being controlled, one skilled in the art will appreciate how the Specific Gravity of the fluid is preprogrammed into the control system 107 or parameterized through the configuration of the differential pressure transmitter.

In one or more embodiments, the control system 107 may include a programmable logic controller (PLC) or logic solver to calculate level differences between the two sensors 106b, 106c. One skilled in the art will appreciate how determining the reference height Hᵣ of the filter medium 111 and determining the differential pressure between the second sensor 106b and the third sensor 106c, the control system 107 determines the height H_{f} of the fluid within the tank 108. In some embodiments, to avoid capillary fill fluid at lower points in the filter device 101, the third sensor 106c may be an electronic remote sensor diaphragm. Additionally, while FIG. 2D discusses one method for determining the fluid level in a tank, those skilled in the art will appreciate that many other methods may be employed to measure fluid level in addition to the methods disclosed herein.

In one or more embodiments, with fluids in the tank 108, the first sensor 106a sends signals to determine if an upper most level within the tank 108 is the height H_{f} of the fluid or the reference height Hᵣ of the filter medium 111. As shown in FIG. 2D, the differential pressure measurement between the measured pressure at the second sensor 106b and the measured pressure at the third sensor 106c determine the height H_{f} of the fluid. Additionally, the first sensor 106a sends further time data packets (see dashed lines T₃ and line T₄), as described above, to the control system 107 to determine an upper most level of a fluid/filter medium mixture within the tank 108. For example, with the fluid and the filter medium 111 in the tank 108, when the first sensor 106a sends a third signal travels downward, the third signal reflects off the upper most level of the fluid/filter medium mixture such that the further time data packets (see dashed lines T₃ and line T₄) correspond to the upper most level. Based on the further time data packets (see dashed lines T₃ and line T₄), the control system 107 determines a height of the upper most level within the tank 108 based on comparing the time data packets of the third signal to the time data packets of the initial signal and the determined height (see H in FIG. 2A) of the tank 108.

In some embodiments, the control system 107 then compares the determined height of the upper most level of the fluid/filter medium mixture to the height H_{f} of the fluid and the reference height Hᵣ of the filter medium 111 to determine if the fluid or the filter medium 111 is the upper most level within the tank 108. By determining the height of the upper most level of the fluid/filter medium mixture, the control system 107 may adjust flow rates (at inlets and/or outlets) to maintain the height H_{f} of the fluid at a predetermined height within the tank 108. For example, as shown in FIG. 2D, the height H_{f} of the fluid may be maintain at a distance D above the reference height Hᵣ of the filter medium 111.

In reference to FIGS. 2E-2H, FIGS. 2E-2H show a non-limiting example a backwashing operation to rejuvenate the filter medium 111 within the filter device 101 after the sequences of FIGS. 2A-2D. As fluids are continuously pumped into the tank 108, the fluids drain out of the tank 108 through the drainage section 115. As such, the continuous fluid flowing from top to bottom of the tank 108 forms a rapid fluid filtration. To determine if a backwashing operation is needed, various parameters may be used to determine when to clean the filter medium 111. For example, samples of fluids within the filter device 101 may be taken to determine a particle count in the filter medium 111 in a laboratory or other suitable place. For example, the fluid sample may be taken at the effluent to check the filter medium 111 effectiveness. If the fluid has a particle count higher than a threshold particle count, the filter medium 111 is due to be cleaned. For example, if the particles per 0.05 ml of volume is greater than 200 or if the milligrams of solids per liter of water (mg/L) (total suspended solids TSS) is greater than 0.2, the filter medium 111 is due for cleaning. Additionally, in one or more embodiments, the fluid may be visually inspected to determine if cleaning is due based on the fluid color changing or if suspended solids are visible. Alternatively or subsequently, if particles are blocking the fluid from flowing through the filter medium 111, a differential pressure head between the lower most end 109 and the upper most end 110 of the tank 108, measured by the sensors, would be high and this indicates that the filter medium 111 needs to be cleaned. For example, the differential pressure head may be set to 25 psi (for high differential pressure) or 30 psi (for high-high differential pressure) to indicate the filter medium 111 needs to be cleaned. Once it is determined that the filter medium 111 needs to be cleaned, the control system 107 may send an alert or a command to start a backwashing operation.

In the backwashing operation, the fluids are drained to be one inch (2.54 centimeters) above the reference height Hᵣ of the filter medium 111.

As the fluid continues to flow through the filter medium 111., the backwashing fluids start to settle in the tank 108, as shown in FIGS. 2E-2G. Now referring to FIG. 2E, in one or more embodiments, the fluid is settled in the tank 108 at a fluid level 119 having a height H_{f2}. To measure the fluid level 119, the second sensor 106b measures a pressure within the tank 108 at the upper most end 110 and the third sensor measures a pressure within the tank 108 at the lower most end 109. The second sensor 106b and the third sensor 106c sends the measured pressure to the control system 107 which is configured to perform a differential pressure measurement. A differential pressure between the second sensor 106b and the third sensor 106c is then be determined and used in a calculation to derive the fluid level 119. For example, the differential pressure may be the measured pressure at the second sensor 106b subtracted from the measured pressure at the third sensor 106c, and the net pressure is used to calculate the fluid level

In one or more embodiments, with the fluid level 119 calculated, the first sensor 106a sends a sixth signal to determine if an upper most level of the fluid/filter medium mixture within the tank 108 is the height H_{f2} of the fluid or the reference height Hᵣ of the filter medium 111. As shown in FIG. 2E, the first sensor 106a sends the sixth signal downward (see dashed line T₇) and reflects off (see dashed line T₈) off the fluid/filter medium mixture within the tank 108 to create the time data packets corresponding to the sixth signal. The first sensor 106a then sends the time data packets corresponding to the sixth signal to the control system 107. Based on the time data packets corresponding to the sixth signal, the control system 107 determines a height of the upper most level of the fluid/filter medium mixture based on comparing the time data packets of the sixth signal to the time data packets of the initial signal and the determined height (see H in FIG. 2A) of the tank 108.

In some embodiments, the control system 107 then compares the determined height of the upper most level of the fluid/filter medium mixture to the height H_{f2} of the fluid and the reference height Hᵣ of the filter medium 111 to determine if the fluid or the filter medium 111 is the upper most level within the tank 108. By determining the height of the upper most level within the tank 108, the control system 107 adjusts flow rates (at inlets and/or outlets) to maintain the height H_{f2} of the fluid at a predetermined height within the tank 108. For example, as shown in FIG. 2D, the height H_{f2} of the backwashing fluid may be maintain at a distance D₂ above the reference height Hᵣ of the filter medium 111. In a specific example, the distance D₂ is one inch (2.54 centimeters).

In one or more embodiments, the height H_{f2} of the fluid determined, the control system 107 may send an alert or a command to start an air scouring cycle. In the air scouring cycle, the control system 107 may control an amount of air being pumped/injected (see block arrows A) through the filter medium 111. The pumped air expands and breaks up compacted grains of the filter medium 111, as well as suspend grains in the backwashing fluid. Further, in one or more embodiments, by having the height H_{f2} of the backwashing fluid one inch (2.54 centimeters) above the reference height Hᵣ of the filter medium 111, the air scouring cycle is enhanced such that the fluid level during air scouring is kept to a height that is most effective for air scouring, so that the life of the filter medium 111 is extended for further use. If the fluid is below the filter media, the air scouring is not effective and decreases the life of the filter medium 111. If the fluid is too high, above one inch (2.54 centimeters), the air cannot wash the particles to the first layer 112 of the filter medium 111. With the measurements taken by sensors/transmitters 106a, 106b, 106c, a fluid level in the filter device 101 may be adjusted precisely to be one inch (2.54 centimeters) above the upper layer of the filter medium 111, which is the recommended level for best air scouring results to break filtered particles to be washed away.

During backwashing operations, and before air scouring, the height H_{f2} of the fluid and the height of the upper most level of the fluid/filter medium mixture is continuously monitored to maintain the height H_{f2} of the fluid one inch (2.54 centimeters) above the reference height Hᵣ of the filter medium 111. For example, as shown in FIG. 2H, the fluid level 119 may drop. The control system 107 may determine when the fluid level 119 drops by repeating the steps above with the first sensor 106a, the second sensor 106b, and the third sensor 106c. For example, the first sensor 106a may send time data packets (see dashed lines T₉ and line T₁₀) to the control system 107 to determine the height of the upper most level within the tank 108. The second sensor 106b and the third sensor 106c send pressure readings so that the control system 107 conduct differential pressure calculation to determine a height H_{f3} of the fluid. The control system 107 then compares the height of the upper most level within the tank 108, the height H_{f3} of the fluid, and the reference height Hᵣ of the filter medium 111 to determine next actions. Those skill in the art will appreciate that monitoring of the fluid level is not necessary at times other than during backwashing operations and before air scouring.

As shown in FIG. 2H, the height H_{f3} of the fluid may drop below the reference height Hᵣ of the filter medium 111. The control system 107 may then send alerts and commands to increase a volume of fluid entering the tank 108. By the increasing the volume of fluid, the fluid level 119 raises back to the height H_{f2} (as shown in FIG. 2G) to be one inch (2.54 centimeters) above the reference height Hᵣ of the filter medium 111. Further, the control system 107 continuously monitors the fluid level 119 and the height of the upper most level within the tank 108 by repeating the steps above with time data packets (see dashed lines T₉ and line T₁₀) of the first sensor 106a and the differential pressure calculations based on pressure readings from the second sensor 106b and the third sensor 106c. Thus, the first sensor 106a (e.g., a radar transmitter) is continuously reading the level of upper surface (water or sand) during backwashing operations. When the fluid is drained below a top layer of the filter medium 111, then the radar will indicate the top filter medium level. At this point, the fluid level is increased to reach the desired one inch above the top layer of the filter medium 111 for optimum air scouring.

After the air scouring cycle is completed, as shown by FIG. 2H, the control system 107 stops pumping air and a backwashing fluid (e.g., clean water) is injected into the tank 108 via the nozzles 105 at the lower most end 109. For example, the backwashing fluid may flow upward (see block arrow Fᵤₚ) from the drainage section 115 and through the filter medium 111 to create a backwashing fluid/filter medium mixture. The backwashing fluids may be continuously pumped upward through the filter medium 111 to continue the filter medium 111 expansion and carrying the particles in suspension. After being pumped through the filter medium 111 for set amount of time, the backwashing fluids may be flushed out through the filter medium 111 via backwash troughs (not shown).

In one or more embodiments, the control system 107 may run the backwashing operations for a fixed time or run the backwashing operations until the filter medium 111 reaches a predetermined quality requirement (e.g., settles back to approximate the initial configuration of the filter bed). Once the control system 107 stops the backwashing operations, the control system 107 may then send alerts and commands to restart treatment operations as shown by FIGS. 2A-2D until further backwash operations are needed.

With reference to FIG. 3, FIG. 3 shows a non-limiting example of the filtration system (see 100 of FIG. 1) displayed on an HMI 300 coupled to the control system (see 107 of FIGS. 1-2H). The HMI 300 may include a touch screen 301 with a scroll down menu 302 to select an operation. When an operation is selected, the HMI 300 may display a plurality of equipment/devices 303, such as the filter device, of a filtration system arranged and connected together as they would be in the filtration system (see 100 of FIG. 1). For example, the components of the filter device 101 may be displayed on the HMI 300. Additionally, a function section 304 of the touch screen 301 may display commands to send to the filter device 101 such that an operator may control the filter device 101 directly through the HMI 300.

The function section 304 may include a command to adjust or stop flow into and out of the filter device 101. The HMI 300 may further display the various components with the filter device 101. For example, a replica of the filter medium 111 within the filter device 101 may be shown at the calculated heights. Additionally, a table section 305 may be displayed on the HMI 300 to display the various levels and heights within the filter device 101 that the control system (see 107 of FIGS. 1-2H) determined. Further, a panel 306 may display alerts and statues of operations being conducted. It is further envisioned that the HMI 300 may have buttons or portions of the touch screen 301 corresponding to commands in the filtration system. Furthermore, the HMI 300 may have a notification of current operations and alarming when the height of the backwashing fluid may drop below the height of the filter medium, such that an automated notification of possible hazards or performance issues may be displayed on the HMI 300.

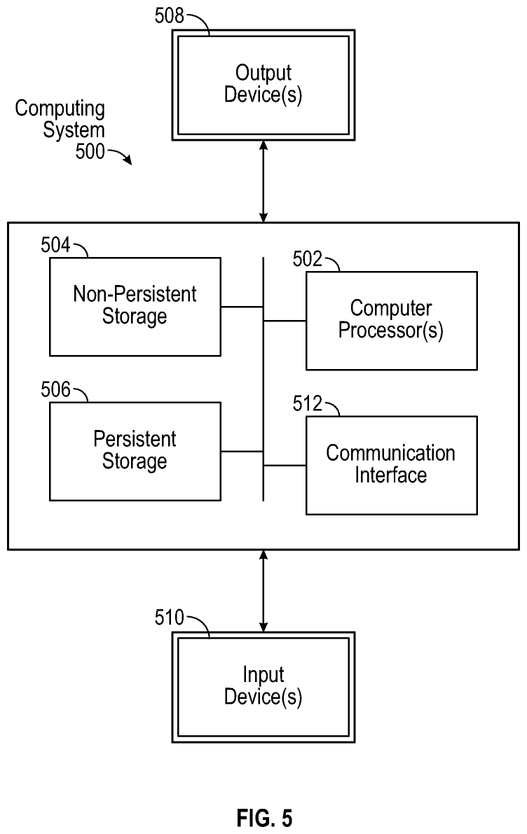

The HMI 300 of FIG. 3 may execute on any suitable computing device, such as a computing device as shown in FIG. 5 below. The computing device may be a computer, a tablet, a smartphone, or any other suitable computing device with processing power and memory.

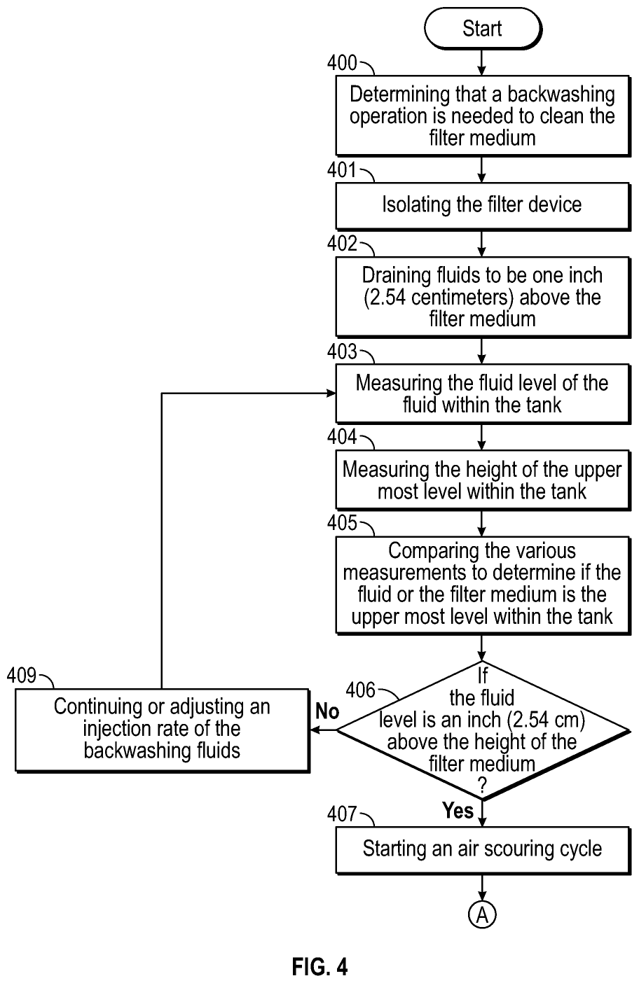

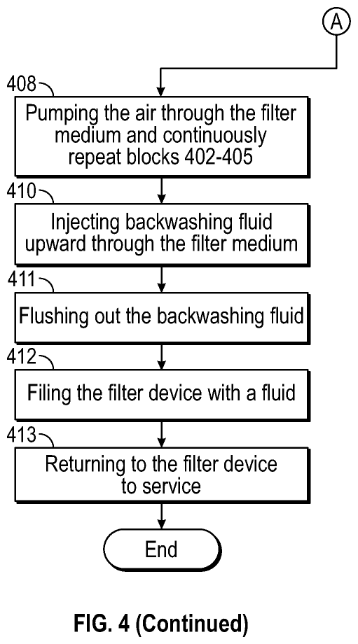

FIG. 4 is a flowchart showing a method of a backwashing operation using the filtration system 100 of FIGS. 1-2H. One or more blocks in FIG. 4 may be performed by one or more components (e.g., a computing system coupled to a controller in communication with the filter device 101) as described in FIGS. 1-2H. For example, a non-transitory computer readable medium may store instructions on a memory coupled to a processor such that the the instructions include functionality for operating the filter device 101. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, as fluids are continuously pumped into the tank of the filter device, various parameters are measured to determine if a backwashing operation is needed to clean the filter medium within the tank. Specifically, in one or more embodiments, samples of fluids within the tank may be taken to determine a particle count in the filter medium. For example, the fluid sample (i.e., water) may be taken at the effluent to check the filter medium effectiveness. If the sampled fluid has a particle count higher than a threshold particle count, the filter medium is due to be cleaned via a backwashing operation. For example, if the particles per 0.05 ml of volume is greater than 200 or if the milligrams of solids per liter of water (mg/L) (total suspended solids TSS) is greater than 0.2, the filter medium 111 is due for cleaning. Additionally, in one or more embodiments, the fluid may be visually inspected to determine if cleaning is due based on the fluid color changing or if suspended solids are visible. Alternatively or subsequently, if particles are blocking the fluid from flowing through the filter medium, a differential pressure head between the lower most end 109 and the upper most end of the tank is higher than a threshold differential pressure head and require the filter medium to be cleaned. For example, the differential pressure head may be set to 25 psi (for high differential pressure) or 30 psi (for high-high differential pressure) to indicate the filter medium 111 needs to be cleaned. Once it is determined that the filter medium needs to be cleaned, an alert or a command may be sent to start a backwashing operation.

In Block 401, to start the backwashing operation, the filter device is isolated from other components in the filtration system. For example, valves may be closed to fluidly isolate the filter device to be offline. Once the filter device is isolated, in Block 402, the fluids are drained to be one inch (2.54 centimeters) above the filter medium. For example, the fluids may be drained out of the tank through the drainage section.

In Block 403, the fluid level of the fluids present in the tank is measured. For example, a differential pressure measurement may be taken between the second sensor and the third sensor and the data is transmitted to the controller. The controller then uses the measured differential pressure in Equation 1 (shown above) to determine the height of the fluid within the tank. In Block 404, with the fluid present in the tank, the height of the upper most level within the tank 108 is measured. The height of the upper most level within the tank 108 is determined by using the first sensor to send signals to reflect off the topmost surface (whether it is the fluid or the filter medium) and create time data packets from this signal.

In Block 405, the controller compares the various measurements to determine if the fluid or the filter medium is the upper most level within the tank. In Block 406, based on the various measurements, the controller determines if the fluid level is one inch (2.54 cm) above the height of the filter medium. If the fluid level is one inch (2.54 cm) above the height of the filter medium, an air scouring cycle is initiated in Block 407. In Block 408, during the air scouring cycle, fresh air is pumped into the tank/vessel through the filter medium, and the method of Blocks 403-406 may continuously repeat. For example, the air may be pumped for 3 minutes. That is, the air scouring cycle may be performed for 3 minutes, approximately. Returning back to Block 406, if the fluid level is not one inch (2.54 cm) above the height of the filter medium, in Block 409, the controller adjusts an injection/drainage rate of the fluids to reach the one inch mark above the height of the filter medium (e.g., sand). For example, if the fluid level is below one inch (2.54 cm), the controller will send a command to increase the volume of fluids being injected and/or decrease the volume of fluids being drained. Alternatively, if the fluid level is above one inch (2.54 cm), the controller will send a command to decrease the volume of fluids being injected and/or increase the volume of fluids being drained. From Block 409, the method may restart back at Block 403 to continue the method.

In Block 410, after the air scouring cycle is completed, backwash fluids are injected upward to go through the filter medium. For example, the backwash fluid may enter the tank via the drainage section and be pushed upward through the filter medium. The backwashing fluids may be continuously pumped upward through the filter medium to continue the filter medium expansion and carrying the particles in suspension. In Block 411, after being pumped through the filter medium for set amount of time, the backwashing fluids may be flushed out through the filter medium via backwash troughs. In Block 412, with the backwashing fluid flushed, the filter device is filled with a fluid to prepare the filter for use. In Block 413, the filter device is returned to service and back online. For example, valve may be opened to fluidly couple the filter device to other components in the filtration system and being treatment operations.

Implementations herein for operating the filtration system 100 may be implemented on control system having a computing system coupled to a controller in communication with the various components of the filtration system 100. Any combination of mobile, desktop, server, router, switch, embedded device, or other types of hardware may be used with the computing system for operating the filtration system 100. For example, as shown in FIG. 5, the computing system 500 may include one or more computer processors 502, non-persistent storage 504 (e.g., volatile memory, such as random access memory (RAM), cache memory), persistent storage 506 (e.g., a hard disk, an optical drive such as a compact disk (CD) drive or digital versatile disk (DVD) drive, a flash memory, etc.), a communication interface 512 (e.g., Bluetooth interface, infrared interface, network interface, optical interface, etc.), and numerous other elements and functionalities. It is further envisioned that software instructions in a form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. For example, the software instructions may correspond to computer readable program code that, when executed by a processor(s), is configured to perform one or more embodiments of the disclosure.

The computing system 500 may also include one or more input devices 510, such as a touchscreen, keyboard, mouse, microphone, touchpad, electronic pen, or any other type of input device. Additionally, the computing system 500 may include one or more output devices 508, such as a screen (e.g., a liquid crystal display (LCD), a plasma display, touchscreen, LED, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing systems exist, and the input and output device(s) may take other forms.

The computing system 500 of FIG. 5 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model. For example, a GUI may first obtain a notification from a software application requesting that a particular data object be presented within the GUI. Next, the GUI may determine a data object type associated with the data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the data object and render a visual representation of the data values within a display device according to the designated rules for that data object type.

Data may also be presented through various audio methods. Data may be rendered into an audio format and presented as sound through one or more speakers operably connected to a computing device. Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

While the method and apparatus have been described with respect to a limited number of embodiments, those skilled in the art, having benefit of this disclosure, will appreciate that other embodiments can be devised which do not depart from the scope as disclosed herein. Accordingly, the scope should be limited only by the attached claims.

What is claimed is:

1. A method for conducting a backwashing operation of a filter medium in a tank, wherein a first height of the filter medium is predetermined based on a first time measurement of a first signal transmitted from a first sensor positioned on a top of the tank, the method comprising:
draining fluids in the tank to be one inch above the filter medium;
pumping air through the filter medium in an air scouring operation;
measuring a second height of the fluid within the tank based on a differential pressure reading of a second sensor and a third sensor positioned on the tank;
measuring a third height of an upper most surface of the fluid/filter medium mixture based on a second time measurement of a second signal transmitted by the first sensor;
determining if the upper most surface of the fluid/filter medium mixture is the fluid or the filter medium based on a difference between the first height and the second height; and
maintaining the second height at a predetermined distance above the first height.

2. The method of claim 1, further comprising continuously injecting the fluids.

3. The method of claim 1, further comprising conducting the air scouring operation for 3 minutes.

4. The method of claim 3, further comprising continuously measuring the second height of the fluid based on a secondary differential pressure reading of the second sensor and the third sensor.

5. The method of claim 4, wherein the predetermined distance is one inch, and wherein the maintaining of the second height at one inch above the first height comprises continuously adjusting a volume of the fluid within the tank based on the continuously measuring the second height of the fluid.

6. The method of claim 3, further comprising draining the fluids and rejuvenating the filter medium for further use.

7. The method of claim 1, wherein the differential pressure reading of the second height comprises subtracting a first pressure reading from the second sensor disposed at an upper most end of the tank from a second pressure reading from the third sensor disposed at a lower most end of the tank.

8. A filtration system comprising:
a filter device, wherein the filter device comprises:
a tank,
a drainage section at a lower most end of the tank,
a filter medium above the drainage section and below an upper most end of the tank, and
a plurality of sensors provided on the tank, wherein a first sensor of the plurality of sensors is on a top of the tank, a second sensor of the plurality of sensors is on an upper most end of the tank, and a third sensor of the plurality of sensors is on a lower most end of the tank,
wherein the first sensor is configured to measure a first height of the filter medium, and
wherein the second sensor and the third sensor are configured to measure a second height of fluids within the tank,
wherein air is configured to be pumped through the filter medium during an air scouring cycle; and
a control system operational coupled to the filter device, wherein the control system is configured to maintain the fluids at the second height at a predetermined distance above the first height during the air scouring cycle.

9. The filtration system of claim 8, wherein if the second height is below the first height, the control system is configured to increase a volume of the fluids to raise the second height to one inch above the first height.

10. The filtration system of claim 8, wherein the first sensor is a radio detection and ranging sensor, and the second sensor and the third sensor are pressure sensors.

11. The filtration system of claim 8, wherein the filter medium is a multilayered media bed comprises a first layer, a second layer below the first layer, and a third layer below the second layer.

12. The filtration system of claim 11, wherein a grain size of the filter medium gradually increases from the first layer to the third layer.

13. The filtration system of claim 8, further comprising a backwashing fluid reservoir fluidly connected to the filter device, wherein backwashing fluids are configured to be injected into the tank and flow upward through the filter medium.

14. The filtration system of claim 8, wherein the control system is a non-transitory computer readable medium storing instructions on a memory coupled to a processor, wherein the instructions comprising functionality to automatically perform backwashing operations.

15. A filtration system comprising:
an untreated fluid reservoir fluidly connected to a filter device, wherein untreated fluids from the untreated fluid reservoir are configured to be injected into the filter device;
a treated fluid reservoir fluidly connected to the filter device, wherein treated fluids from the filter device are configured to be injected the untreated fluid reservoir;
a waste fluid reservoir fluidly connected to the filter device, wherein waste fluids from the filter device are configured to be injected the waste fluid reservoir;
wherein the filter device comprises:
a tank;
a drainage section at a lower most end of the tank;
a filter medium above the drainage section and below an upper most end of the tank;
a plurality of sensors provided on the tank, the plurality of sensors being configured to measure a first height of the filter medium within the tank and measure a second height of fluids within the tank; and
a control system configured to maintain, by increasing or decreasing a volume of the fluids, the second height a predetermined distance above the first height based on data from the plurality of sensors.

16. The filtration system of claim 15, wherein a first sensor of the plurality of sensors is on a top of the tank, a second sensor of the plurality of sensors is on an upper most end of the tank, and a third sensor of the plurality of sensors is on a lower most end of the tank.

17. The filtration system of claim 16, wherein the first sensor is a radio detection and ranging sensor, and the second sensor and the third sensor are pressure sensors.

18. The filtration system of claim 15, wherein the filter medium is a multilayered media bed.

19. The filtration system of claim 15, wherein the control system is coupled to a human machine interface to display the data from the plurality of sensors.

20. The filtration system of claim 15, wherein the control system is a non-transitory computer readable medium storing instructions on a memory coupled to a processor, wherein the instructions comprising functionality to automatically operate the filter device.
